(19) United States
(12) Patent Application Publication
(10) Pub. No.: US 2015/0109346 A1
(43) Pub. Date: Apr. 23, 2015

(54) DISPLAY DEVICE, DISPLAY DEVICE CONTROL METHOD, TELEVISION RECEIVER, AND RECORDING MEDIUM

(71) Applicant: SHARP KABUSHIKI KAISHA, Osaka-shi, Osaka (JP)

(72) Inventors: Shigeki Taniguchi, Osaka-shi (JP); Michiyuki Sugino, Osaka-shi (JP); Akira Koike, Osaka-shi (JP); Mihoko Watanabe, Osaka-shi (JP)

(73) Assignee: SHARP KABUSHIKI KAISHA, Osaka-shi, Osaka (JP)

(21) Appl. No.: 14/398,807

(22) PCT Filed: Mar. 27, 2013
(86) PCT No.: PCT/JP2013/059072

§ 371 Date: Nov. 4, 2014

(30) Foreign Application Priority Data
May 15, 2012 (JP) 2012-111955
Mar. 26, 2013 (JP) 2013-065206

(51) Int. Cl. G09G 3/34; G09G 3/36

(52) U.S. Cl. CPC G09G 3/3406; G09G 3/3611; G09G 2330/023
USPC 345/690; 345/102

(57) ABSTRACT

A backlight control circuit (3) controls a blinking frequency of light emitted by a backlight (6), in accordance with brightness of a video to be displayed on a display section (7), for the purpose of reproducing, with a simpler process, a feeling of shutter which is felt when a film movie is projected by a projector, without causing a user to feel a feeling of discomfort.

### TECHNICAL FIELD

The present invention relates to (i) a display device which displays a video, (ii) a method of controlling a display device, (iii) a television receiver, (iv) a control program, and (v) a recording medium.

### BACKGROUND ART

Televisions have become higher in resolution, so that high-resolution televisions and full-high-resolution televisions are becoming popular. Under such circumstances, BDs (Blu-ray Discs) of old movies are released which movies have been remastered by distributors such as a movie company. Therefore, a user can generally enjoy old movies of high quality.

Meanwhile, the old movies turn to bright and clear videos by being remastered so as to have high image quality. This causes the user to feel like the user is watching television dramas. Accordingly, the user cannot feel like the user is watching the old movies at old movie theaters.

In view of the circumstances, techniques, of reproducing old movies of high image quality so that a user can feel like the user is watching the old movies at old movie theaters, have been developed. For example, Patent Literature 1 discloses a technique of giving such an effect that an old shutter-type projector is used in a movie theater, by controlling light-emission of a backlight so as to cause blinking of light. Further, Patent Literature 2 discloses a technique of reproducing a feeling of flicker or a double image at a multiple frequency (48 Hz) which are expressed in a conventional movie theater, by generating a high-frequency enhanced image and a low-frequency image from an inputted image and alternately reading and displaying the high-frequency highlighted image and the low-frequency image.

### CITATION LIST

Patent Literature 1
Japanese Patent Application Publication, Tokukai, No. 2012-8515 A (Publication Date: Jan. 12, 2012)
Patent Literature 2
Japanese Patent Application Publication, Tokukai, No. 2011-17936 A (Publication Date: Jan. 27, 2011)

### SUMMARY OF INVENTION

### Technical Problem

However, the technique disclosed in Patent Literature 1 causes a flicker to occur on a television. Therefore, there is a possibility that, depending on a video which the user is watching, the user strongly feels a feeling of flicker rather than a feeling of shutter and, accordingly, feels a feeling of discomfort. Meanwhile, according to the technique disclosed in Patent Literature 2, there are problems that (i) a process is complicated and (ii) memory use is large.

The present invention has been made in view of the above problems, and an object of the present invention is to provide a display device, a method of controlling a display device, a television receiver, a control program, and a recording medium, each of which reproduces, with a simpler process, a feeling of shutter which is felt when a film movie is projected by a projector, without causing a user to feel a feeling of discomfort.

### Solution to Problem

In order to attain the above object, a display device in accordance with an embodiment of the present invention is a display device, which displays a video on a display section including a backlight, including: backlight control means for controlling a blinking frequency of light emitted by the backlight, the backlight control means controlling the blinking frequency of the light emitted by the backlight, in accordance with brightness of the video.

Further, in order to attain the above object, a method of controlling a display device in accordance with an embodiment of the present invention is a method of controlling a display device which displays a video on a display section including a backlight, including the step of: (a) controlling a blinking frequency of light emitted by the backlight, in the step (a), the blinking frequency of the light emitted by the backlight being controlled in accordance with brightness of the video.

### Advantageous Effects of Invention

According to an aspect of the present invention, it is possible to reproduce, with a simpler process, a feeling of shutter which is felt when a film movie is projected by a projector, without causing a user to feel a feeling of discomfort.

### BRIEF DESCRIPTION OF DRAWINGS

FIG. 1 is a block diagram illustrating a configuration of a main part of a display device in accordance with an embodiment of the present invention.

FIG. 2 is a view illustrating an example of frequency specifying information indicative of a correspondence between an APL and a target blinking frequency.

FIG. 3 is a view illustrating an example of frequency specifying information indicative of a correspondence between (i) a proportion of an area in which brightness is not less than 70% and (ii) a target blinking frequency.

FIG. 4 is a view illustrating an example of a brightness histogram prepared by a video processing circuit from a video signal.

FIG. 5 is a flowchart illustrating an example of a first process which is carried out, in a movie (classic) mode, by the display device.

FIG. 6 is a flowchart illustrating an example of a second process which is carried out, in a movie (classic) mode, by the display device.

FIG. 7 is a view illustrating an example of frequency specifying information indicative of a correspondence between an APL and a target blinking frequency.

FIG. 8 is a block diagram illustrating a configuration of a main part of a display device in accordance with another embodiment of the present invention.

FIG. 9 is a view illustrating an example of second frequency specifying information indicative of a correspondence between (i) a proportion of a text region and (ii) a second target blinking frequency.

FIG. 10 is a flowchart illustrating an example of a third process which is carried out, in a movie (classic) mode, by the display device.

### DESCRIPTION OF EMBODIMENTS

### Outline of the Present Invention

In a case where (i) a feeling of shutter is reproduced with the use of the technique disclosed in Patent Literature 1 and (ii) a displayed video (image) is bright, blinking of the displayed video is noticeable. This causes a flicker to excessively occur. Further, in a case where a bright part of a whole video is large in area, a flicker in the bright part becomes intensive. This may cause a user to feel a feeling of discomfort.

In view of the circumstances, a display device in accordance with the present invention controls, in accordance with brightness of a video to be displayed, a blinking process carried out by a backlight, in order to reproduce a feeling of shutter, which is felt when a film movie is projected by a projector, without causing the user to feel a feeling of discomfort. Specifically, the display device in accordance with the present invention controls a frequency of blinking (blinking frequency) of the backlight so that, as the video to be displayed becomes brighter, the blinking frequency becomes higher.

By thus changing the blinking frequency of the backlight in accordance with the brightness of the video, it is possible to reproduce a feeling of shutter, which is felt when a film movie is projected by a projector, without causing the user to feel a feeling of discomfort.

Note that, as an indicator indicative of a degree of brightness of a video, (i) an APL (Average Picture Level) of the video or (ii) a proportion of a bright region to an entire screen is, for example, used. Note here that a screen (1 (one) frame) is divided into a plurality of regions, and APLs of the respective plurality of regions are calculated. Under the circumstances, the “proportion of a bright region to an entire screen” means a proportion of (i) a region(s) in which a corresponding APL is equal to or more than a predetermined level to (ii) the entire screen.

More specifically, the display device specifies a target blinking frequency corresponding to the brightness of the video, and gradually increases or decreases a blinking frequency of light emitted by the backlight so that the blinking frequency is identical to the target blinking frequency thus specified. Note here that a target blinking frequency indicates a blinking frequency suitable for the brightness of the video.

The brightness of the video minutely varies even in successive frames. Therefore, in a case where the blinking frequency is changed merely in accordance with the brightness, such a minute change in blinking frequency may cause the user to feel a feeling of discomfort. Alternatively, there is a case where the brightness of the video suddenly varies. In a case where the blinking frequency is changed in accordance with such a sudden variation of the brightness, this causes the user to feel a feeling of discomfort. In view of the circumstances, according to the present invention, the blinking frequency is not immediately changed to the blinking frequency suitable for the brightness of the video, but is controlled so as to gradually become closer to the blinking frequency suitable for the brightness of the video. This makes it possible to reproduce a feeling of shutter in accordance with the brightness of the video, without causing the user to feel a feeling of discomfort.

Note that a blinking frequency which is set to the backlight and at which the backlight is actually operated is hereinafter referred to as a set blinking frequency.

### Embodiment 1

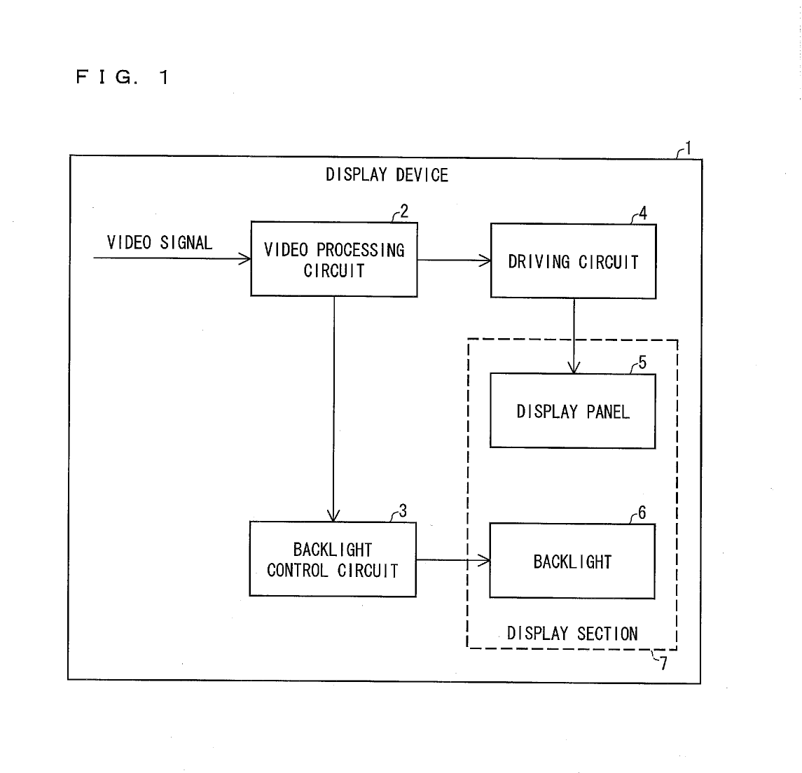

First, the following description will discuss Embodiment 1 of the present invention with reference to FIGS. 1 through 7.

[Configuration of Display Device]

A display device in accordance with Embodiment 1 will be described below with reference to FIG. 1. The display device in accordance with Embodiment 1 is a device which displays an image, and examples of the display device include a digital television, a PC monitor, a mobile phone, a PDA (Personal Digital Assistant), a game machine, an electronic blackboard, a digital camera, and a video camera. Note that a television receiver including the display device also falls within the scope of the present invention disclosed in the specification.

Examples of an image quality adjusting mode, which the display device in accordance with Embodiment 1 has, encompass a movie (classic) mode, a game mode, and a normal movie mode. The movie (classic) mode is an image quality adjusting mode in which, in a case where a video of an old classic movie is displayed, the video has an image quality (given image quality) that causes the foregoing unique fineness, noise, a flicker, and/or like to be reproduced as much as possible.

FIG. 1 is a block diagram illustrating an example configuration of a main part of a display device 1. As illustrated in FIG. 1, the display device 1 includes a video processing circuit (frequency specifying means) 2, a backlight control circuit (backlight control means) 3, a driving circuit 4, a display panel 5, and a backlight 6. Note that the display device 1 can include (i) a communication section, an antenna, and the like via each of which a video signal is externally transmitted, (ii) a storing section which stores therein a video signal, (iii) a decoding section, a tuner, and the like via each of which a video signal is decoded, (iv) an operating section, (v) an audio input section, and/or (vi) an audio output section. Note, however, that those members are not illustrated in FIG. 1 because the members are not related to any feature of the present invention.

The video processing circuit 2 makes an adjustment with respect to an image quality of an obtained video and/or carries out scaling with respect to the obtained video. Note here that the adjustment of an image quality means, for example, a modification of at least one of brightness, sharpness, and contrast. Note also that the scaling means a reduction in size of a video to be displayed while retaining an intended aspect ratio of the video. The video processing circuit 2 supplies, to the driving circuit 4, a video signal which has been subjected to such image quality adjustment and scaling.

In the movie (classic) mode, the video processing circuit 2 further calculates brightness of the obtained video and specifies a target blinking frequency corresponding to the brightness thus calculated, with reference to frequency specifying information indicative of a correspondence between brightness of a video and a target blinking frequency.

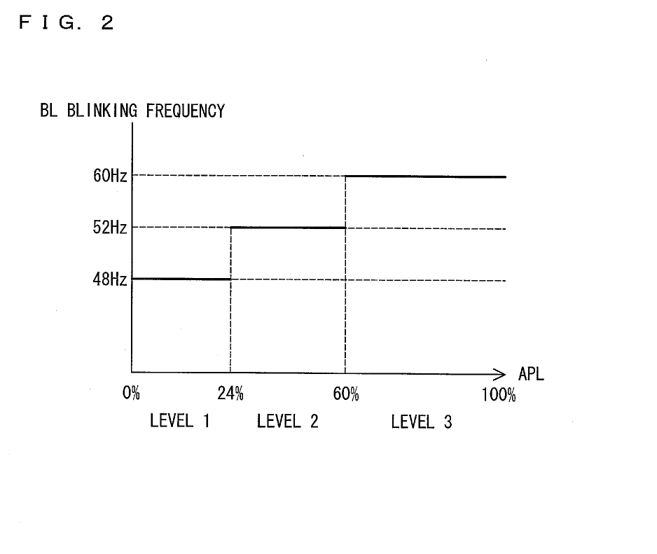

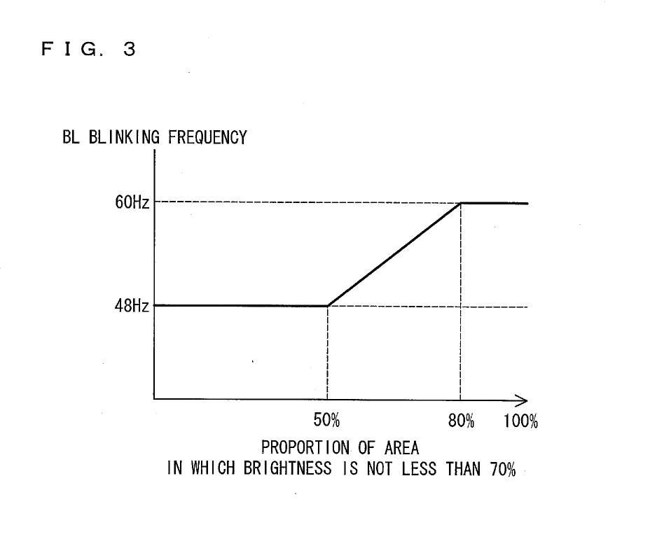

Here, the frequency specifying information will be described below with reference to FIGS. 2 and 3. FIG. 2 is a view illustrating an example of frequency specifying information indicative of a correspondence between an APL and a target blinking frequency. FIG. 3 is a view illustrating an example of frequency specifying information indicative of a correspondence between (i) a proportion of an area in which brightness is not less than 70% and (ii) a target blinking frequency.

According to each frequency specifying information, the target blinking frequency increases in proportion to brightness of a video (see FIGS. 2 and 3). According to the example illustrated in FIG. 3, the target blinking frequency continuously varies depending on the brightness (the proportion of the area in which brightness is not less than 70%). According to FIG. 2, the APL is classified into three levels, and each target blinking frequency is set to a corresponding one of the three levels. That is, a blinking frequency suitable for brightness of a corresponding level of the APL is set as the each target blinking frequency. Since the APL minutely varies depending on a video, it is possible to suppress a minute variation of the target blinking frequency by thus setting the target blinking frequency stepwise. Accordingly, it is possible to suppress a wasteful process.

According to Embodiment 1, (i) a lower limit of the target blinking frequency is set to 48 Hz which corresponds to a frequency of a shutter of the projector and (ii) an upper limit of the target blinking frequency is set to 60 Hz which corresponds to a general refresh rate (see FIGS. 2 and 3). Note, however, that the lower limit and the upper limit of the target blinking frequency are not limited to such respective frequencies, and can be therefore set as appropriate.

Next, a process will be described below which is carried out by the video processing circuit 2 in a case where the frequency specifying information illustrated in FIG. 2 is used. In this case, in the movie (classic) mode, the video processing circuit 2 calculates an APL in 1 (one) frame from an obtained video signal and specifies a target blinking frequency corresponding to the APL thus calculated. The video processing circuit 2 notifies the backlight control circuit 3 of the target blinking frequency thus specified. Alternatively, the video processing circuit 2 can calculate the APL, specify the target blinking frequency, and specify a level of the APL. In this case, the video processing circuit 2 notifies the backlight control circuit 3 of the target blinking frequency and the level of the APL.

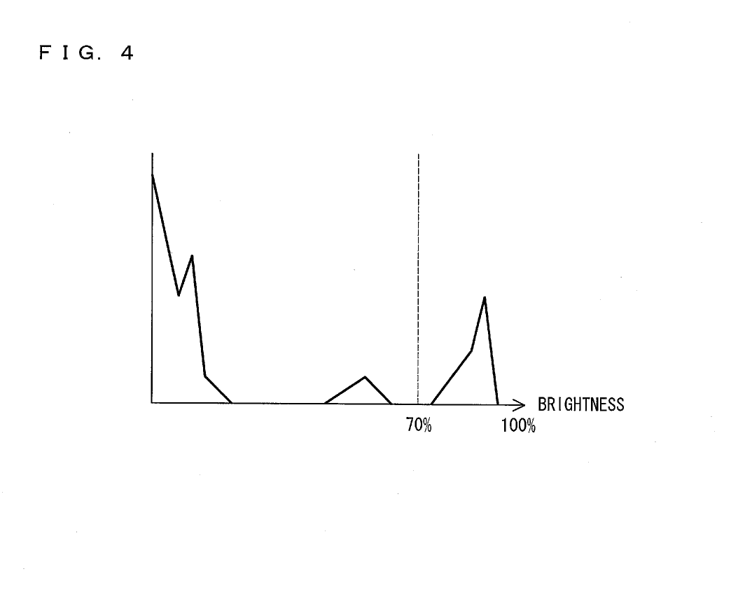

Next, a process will be described below which is carried out by the video processing circuit 2 in a case where the frequency specifying information illustrated in FIG. 3 is used. In this case, the video processing circuit 2 prepares, in the movie (classic) mode, a brightness histogram in 1 (one) frame from an obtained video signal. For example, the video processing circuit 2 prepares a brightness histogram as illustrated in FIG. 4. The video processing circuit 2 then calculates, from the brightness histogram thus generated, a proportion of an area in which brightness is not less than 70%, and specifies a target blinking frequency corresponding to the proportion thus calculated. Thereafter, the video processing circuit 2 notifies the backlight control circuit 3 of the target blinking frequency thus specified.

Note that the video processing circuit 2 can obtain a video signal from a device outside the display device 1 via an antenna (not illustrated) or a communication section (not illustrated). Alternatively, the video processing circuit 2 can obtain a video signal by reading out the video signal from, for example, a storing section (not illustrated) included in the display device 1.

The backlight control circuit 3 controls, for example, (i) a time point (timing) when the backlight 6 emits light, (ii) a time period in which the backlight 6 emits light (time period in which the backlight 6 does not emit light), and (iii) an intensity of light emitted by the backlight 6.

In a case where the movie (classic) mode is set, the backlight control circuit 3 controls a blinking frequency of light emitted by the backlight 6 so that a feeling of shutter, which is felt when a film movie is projected by a projector, is reproduced. For example, the backlight control circuit 3 controls the backlight 6 to operate at a blinking frequency of 48 Hz.

Note that, in the movie (classic) mode, the backlight control circuit 3 obtains a target blinking frequency from the video processing circuit 2, and then controls, in accordance with the target blinking frequency thus obtained, the blinking frequency of light emitted by the backlight 6. Specifically, the backlight control circuit 3 determines, for each frame, whether or not a set blinking frequency is different from the target blinking frequency. In a case where the set blinking frequency is different from the target blinking frequency, the backlight control circuit 3 gradually increases or decreases, for each frame, the set blinking frequency so that the set blinking frequency is identical to the target blinking frequency. In other words, in a case where the set blinking frequency is different from the target blinking frequency, the backlight control circuit 3 increases or decreases, for each predetermined time period, the set blinking frequency by a predetermined amount so that the set blinking frequency is identical to the target blinking frequency. Note that, in a case where the set blinking frequency is identical to the target blinking frequency, the backlight control circuit 3 remains the set blinking frequency unchanged, instead of changing the set blinking frequency.

More specifically, in a case where the set blinking frequency is higher than the target blinking frequency, the backlight control circuit 3 decreases, for each frame by the predetermined amount, the set blinking frequency so that the set blinking frequency is identical to or closer to the target blinking frequency. In a case where the set blinking frequency is lower than the target blinking frequency, the backlight control circuit 3 increases, for each frame by the predetermined amount, the set blinking frequency so that the set blinking frequency is identical to or closer to the target blinking frequency.

By thus causing the set blinking frequency to gradually become closer to a blinking frequency suitable for brightness of a video, it is possible to suppress a sudden change in image. It is therefore possible to (i) avoid causing a user to mistakenly consider that the display device is broken and (ii) lessen a burden on the user which burden is caused by a change in blinking frequency.

In this case, the backlight control circuit 3 decreases the set blinking frequency by an amount smaller than an amount by which the backlight control circuit 3 increases the set blinking frequency. In a case where the set blinking frequency is decreased, a feeling of flicker is strengthened. Therefore, by decreasing the set blinking frequency by a smaller amount, it is possible to prevent the feeling of flicker from being suddenly strengthened.

Alternatively, in the movie (classis) mode, in a case where the backlight control circuit 3 receives a target blinking frequency and a level of an APL from the video processing circuit 2, the backlight control circuit 3 determines whether or not the level of the APL has changed from a previous level. In a case where the level of the APL is higher than the previous level, the backlight control circuit 3 increases a set blinking frequency by a predetermined amount so that the set blinking frequency is identical to or closer to the target blinking frequency. In a case where the level of the APL is lower than the previous level, the backlight control circuit 3 decreases the set blinking frequency by a predetermined amount so that the set blinking frequency is identical to or closer to the target blinking frequency. In a case where the level of the APL has not changed from the previous level, the backlight control circuit 3 determines whether or not the set blinking frequency is different from the target blinking frequency, and then gradually increases or decreases the set blinking frequency so that the set blinking frequency is identical to the target blinking frequency.

Note that, in the movie (classic) mode, the backlight control circuit 3 can alternatively obtain a target blinking frequency from the video processing circuit 2 and then control a blinking frequency of light emitted by the backlight 6 by setting the target blinking frequency thus obtained as a set blinking frequency.

Here, in a case where the set blinking frequency is 48 Hz, the backlight control circuit 3 realizes blinking, at a frequency of 48 Hz, of a video whose frequency is 24 Hz, by repeating (i) a light-emitting time period of 1/96 seconds and (ii) a non-light-emitting time period of 1/96 seconds. By reducing both of the light-emitting time period and the non-light-emitting time period, a blinking frequency of the backlight 6 is increased. In a case where the blinking frequency is increased, the feeling of shutter, which the user feels, tends to be reduced. Note that, in Embodiment 1, a default set blinking frequency in the movie (classic) mode is 48 Hz.

As has been described, a target blinking frequency is specified in accordance with brightness of a video to be displayed. That is, the backlight control circuit 3 controls, in accordance with brightness of a video to be displayed, a blinking frequency of light emitted by the backlight 6.

The driving circuit 4 receives a video signal from the video processing circuit 2 and controls, in accordance with the video signal thus received, an amount of light which each of pixels in a display panel transmits.

The display panel 5 has pixels such as RGB pixels. The display panel 5 displays a video by causing each of the pixels to transmit light emitted by the backlight 6. Examples of the display panel 5 include a liquid crystal panel.

The backlight 6 is a direct LED backlight which emits light toward the display panel 5. Note, however, that the backlight 6 is not limited to such a direct LED backlight, and can be alternatively an edge light type backlight or another light source such as a cold cathode fluorescent tube.

In Embodiment 1, a section which includes, as illustrated in FIG. 1, the display panel 5 and the backlight 6 is referred to as a display section 7. In other words, the display section 7 is a section for displaying a video. Note that a section which includes the display panel 5, the backlight 6, the backlight control circuit 3 and/or the driving circuit 4 can be alternatively referred to as a display section 7.

[First Process Carried Out by Display Device]

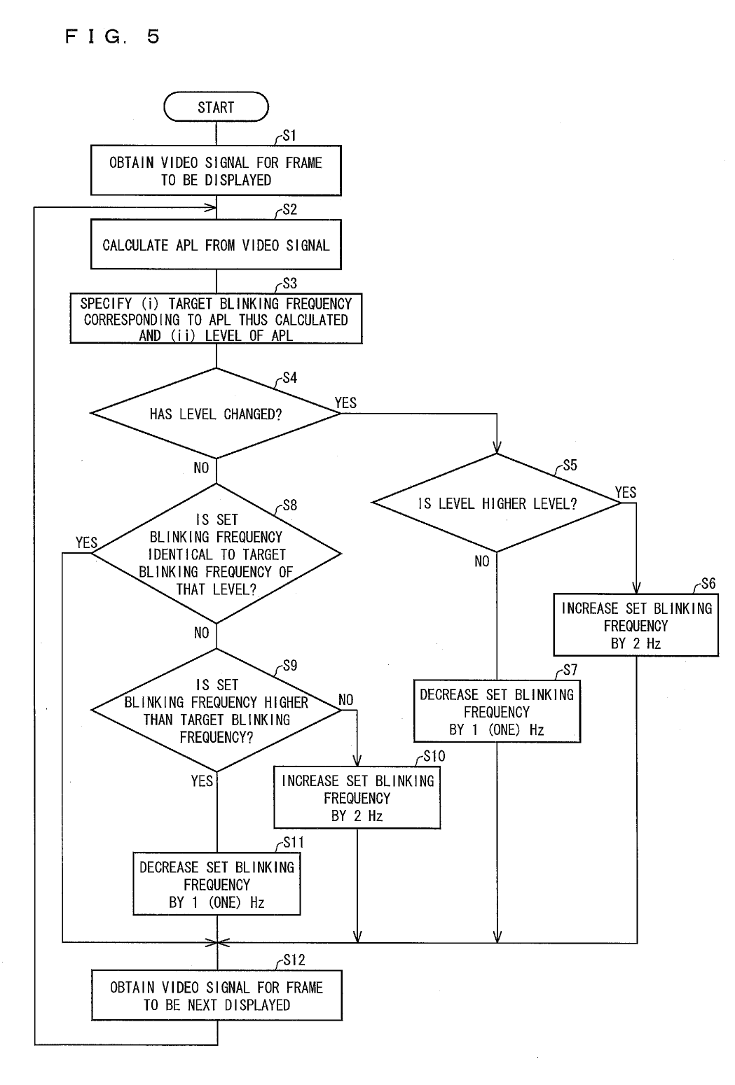

Next, with reference to FIG. 5, a first process will be described which is carried out, in the movie (classic) mode, by the display device. FIG. 5 is a flowchart illustrating an example of the first process which is carried out, in the movie (classic) mode, by the display device.

Here, it is assumed that the video processing circuit 2 notifies the backlight control circuit 3 of a target blinking frequency and a level of an APL with reference to the frequency specifying information illustrated in FIG. 2. It is also assumed that (i) a set blinking frequency is increased or decreased for each frame and (ii) the set blinking frequency is increased by 2 Hz and decreased by 1 (one) Hz.

As illustrated in FIG. 5, the video processing circuit 2 obtains a video signal for a frame to be displayed (step S1). The video processing circuit 2 calculates an APL from the video signal thus obtained (step S2). The video processing circuit 2 specifies, with reference to the frequency specifying information illustrated in FIG. 2, (i) a target blinking frequency corresponding to the APL thus calculated and (ii) a level of the APL (step S3), and notifies the backlight control circuit 3 of the target blinking frequency and the level of the APL thus specified.

In a case where the backlight control circuit 3 receives the target blinking frequency and the level of the APL from the video processing circuit 2, the backlight control circuit 3 determines whether or not the level thus received has changed from a previous level (step S4). In a case where (i) the level has changed from the previous level (Yes, in the step S4) and (ii) the level is higher than the previous level (Yes, in step S5), the backlight control circuit 3 increases the set blinking frequency by 2 Hz (step S6). In a case where (i) the level has changed from the previous level (Yes, in the step S4) and (ii) the level is lower than the previous level (No, in the step S5), the backlight control circuit 3 decreases the set blinking frequency by 1 (one) Hz (step S7).

On the other hand, in a case where the level has not changed from the previous level (No, in the step S4), the backlight control circuit 3 determines whether or not such a current set blinking frequency is identical to the target blinking frequency which has been notified (step S8). In a case where the current set blinking frequency is not identical to the target blinking frequency (No, in the step S8), the backlight control circuit 3 then determines whether the current set blinking frequency is higher or lower than the target blinking frequency (step S9). In a case where the current set blinking frequency is lower than the target blinking frequency (No, in the step S9), the backlight control circuit 3 increases the set blinking frequency by 2 Hz (step S10). In a case where the current set blinking frequency is higher than the target blinking frequency (Yes, in the step S9), the backlight control circuit 3 decreases the set blinking frequency by 1 (one) Hz (step S11).

Note that, in a case where the current set blinking frequency is identical to the target blinking frequency (Yes, in the step S8), the backlight control circuit 3 maintains the current set blinking frequency as it is.

After the backlight control circuit 3 carries out the process (step S6, S7, S10, or S11 or Yes in the step 8), the video processing circuit 2 waits to receive a video signal for a next frame. In a case where the video processing circuit 2 receives the video signal for the next frame (step S12), the process in the step S2 and the processes in subsequent steps are again carried out.

[Second Process Carried Out by Display Device]

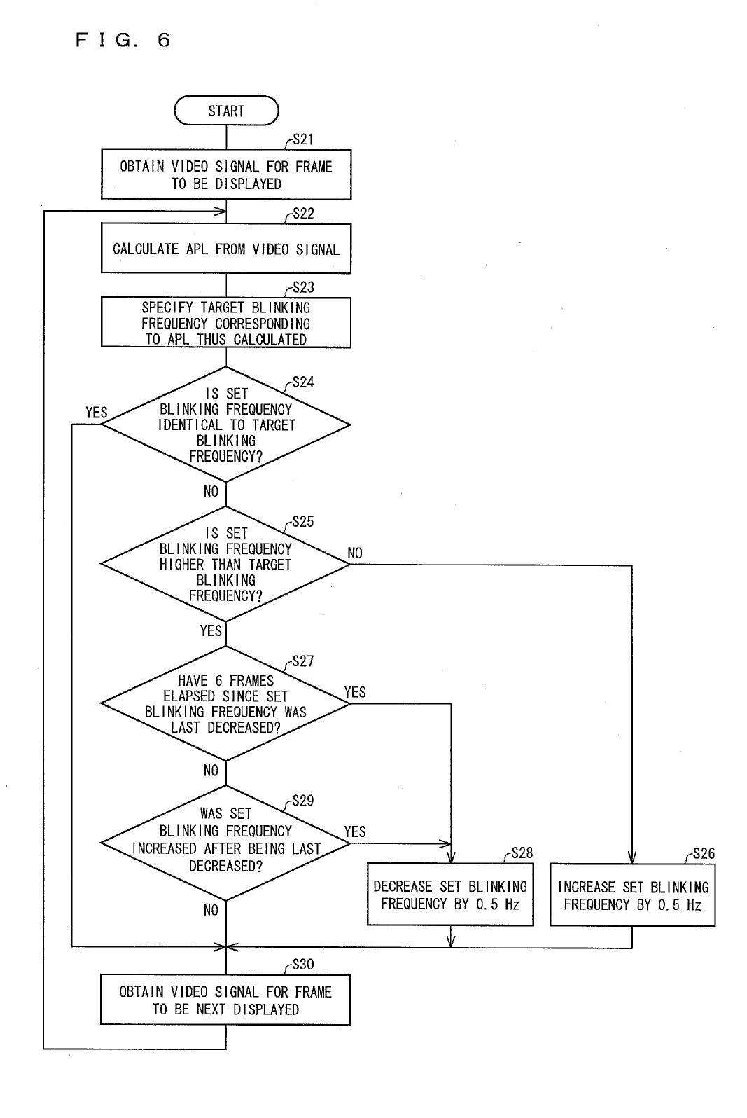

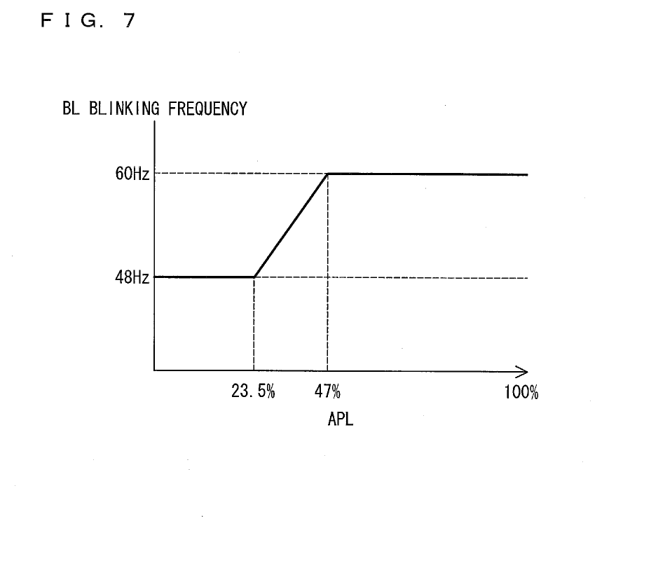

Next, with reference to FIGS. 6 and 7, a second process will be described which is carried out, in the movie (classic) mode, by the display device. FIG. 6 is a flowchart illustrating an example of the second process which is carried out, in the movie (classic) mode, by the display device. FIG. 7 is a view illustrating frequency specifying information indicative of a correspondence between an APL and a target blinking frequency, which frequency specifying information is used in the second process.

Here, it is assumed that the video processing circuit 2 notifies the backlight control circuit 3 of a target blinking frequency with reference to the frequency specifying information illustrated in FIG. 7. It is also assumed that (i) the set blinking frequency is increased for every 1 (one) vertical scanning period (1 (one) frame) by 0.5 Hz and (ii) the set blinking frequency is decreased for every 6 vertical scanning periods (6 frames) by 0.5 Hz. That is, according to the second process, in a case where the backlight control circuit 3 increases or decreases a blinking frequency, the backlight control circuit 3 sets, to a given amount, an amount by which the backlight control circuit 3 increases or decreases the blinking frequency, and sets a decrease interval, between (i) a time point when the backlight control circuit 3 decreased the blinking frequency and (ii) a time point when the backlight control circuit 3 next decreases the blinking frequency, so as to be longer than an increase interval, between (a) a time point when the backlight control circuit 3 increased the blinking frequency and (b) a time point when the backlight control circuit 3 next increases the blinking frequency.

As illustrated in FIG. 6, the video processing circuit 2 obtains a video signal for a frame to be displayed (step S21). The video processing circuit 2 calculates an APL from the video signal thus obtained (step S22). The video processing circuit 2 specifies, with reference to the frequency specifying information illustrated in FIG. 7, a target blinking frequency corresponding to the APL thus calculated (step S23), and notifies the backlight control circuit 3 of the target blinking frequency thus specified.

The backlight control circuit 3 determines whether or not a current set blinking frequency is identical to the target blinking frequency thus notified (step S24). In a case where the current set blinking frequency is not identical to the target blinking frequency (No, in the step S24), the backlight control circuit 3 then determines whether the current set blinking frequency is higher or lower than the target blinking frequency (step S25). In a case where the current set blinking frequency is lower than the target blinking frequency (No, in the step S25), the backlight control circuit 3 increases the set blinking frequency by 0.5 Hz (step S10).

In a case where the current set blinking frequency is higher than the target blinking frequency (Yes, in the step S25), the backlight control circuit 3 determines whether or not 6 frames have elapsed since the backlight control circuit 3 last decreased a set blinking frequency (step S27). In a case where 6 frames have elapsed since the backlight control circuit 3 last decreased the set blinking frequency (Yes, in the step S27), the backlight control circuit 3 decreases the current set blinking frequency by 0.5 Hz (step S28). In a case where 6 frames have not yet elapsed since the backlight control circuit 3 last decreased the set blinking frequency (No, in the step S27), the backlight control circuit 3 then determines whether or not to have increased the set blinking frequency after last decreasing the set blinking frequency (step S29). In a case where the backlight control circuit 3 increased the set blinking frequency after last decreasing the set blinking frequency (Yes, in the step S29), the backlight control circuit 3 decreases the current set blinking frequency by 0.5 Hz (step S28). In a case where the backlight control circuit 3 did not increase the set blinking frequency after last decreasing the set blinking frequency (No, in the step S29), the backlight control circuit 3 maintains the current set blinking frequency as it is.

Note that, in a case where the current set blinking frequency is identical to the target blinking frequency (Yes, in the step S24), the backlight control circuit 3 maintains the current set blinking frequency as it is.

After the backlight control circuit 3 carries out the process (step S26 or S28, No in the step S29, or Yes in the step S24), the video processing circuit 2 waits to receive a video signal for a next frame. In a case where the video processing circuit 2 receives the video signal for the next frame (step S30), the process in the step S2 and the processes in subsequent steps are again carried out.

Note that, alternatively, the backlight control circuit 3 can always maintain the current set blinking frequency as it is, instead of carrying out a determination process in the step S29, in a case where 6 frames have not yet elapsed since the backlight control circuit 3 last decreased the set blinking frequency.

[Variation 1]

The display device 1 can be arranged such that (a) the backlight 6 is divided into a plurality of regions and (b) the backlight control circuit 3 controls, for each of the plurality of regions, (i) a time point (timing) when the backlight 6 emits light, (ii) a time period in which the backlight 6 emits light (time period in which the backlight 6 does not emit light), (iii) an intensity of light emitted by the backlight 6, and the like. That is, the backlight control circuit 3 can carry out a so-called local dimming control.

In this case, the backlight control circuit 3 can merely control one or more of the plurality of regions of the backlight 6, which one or more of the plurality of regions corresponds to a region on the display panel 5 in which region a video is being displayed, to operate at a set blinking frequency. That is, the backlight control circuit 3 reproduces the feeling of shutter, which is felt when a film movie is projected by a projector, merely in a region on a screen in which region the video is being displayed.

For example, in a case where a data broadcast is being displayed, the backlight control circuit 3 controls a region of the backlight 6, which region corresponds to a region in which the data broadcast such as a text or an icon is being displayed, to normally operate, and controls merely a region of the backlight 6, which region corresponds to a region in which a video is being displayed, to operate in the movie (classic) mode.

[Variation 2]

Note that, in Embodiment 1, the video processing circuit 2 specifies a target blinking frequency for each frame. However, Embodiment 1 is not limited to such. For example, the video processing circuit 2 can specify a target blinking frequency for every plurality of frames. In this case, the video processing circuit 2 is only necessary to specify the target blinking frequency in accordance with average brightness of the plurality of frames.

Note also that, in Embodiment 1, the backlight control circuit 3 increases or decreases a set blinking frequency for each frame or for every 6 frames. However, Embodiment 1 is not limited to such. Such increase intervals and decrease intervals do not need to be set on a frame basis, but can be set to any time period as appropriate. Moreover, an amount by which a set blinking frequency is increased or decreased can be set to any amount as appropriate.

### Embodiment 2

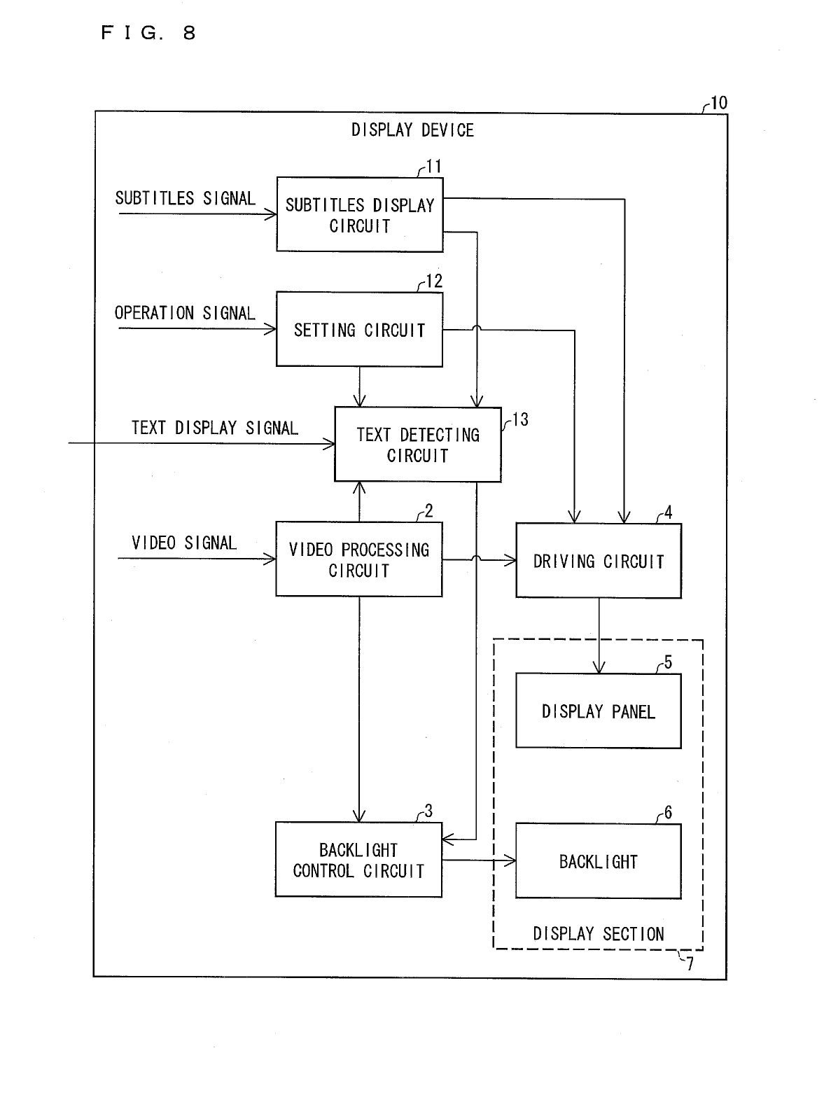

In a case where a proportion of a text region in a video is increased, blinking of the text region is noticeable. This causes a flicker to excessively occur. In Embodiment 2, in order to suppress a flicker caused by displaying a text, a blinking frequency of a backlight is controlled in accordance with not only brightness of a video but also a proportion of a region of the video in which region the text is displayed (text region). Embodiment 2 of the present invention will be described below with reference to FIGS. 8 through 10.

Note that, for convenience of explanation, identical reference numerals will be given to respective members having functions identical to those of the members described in Embodiment 1, and explanation of the members will be omitted. Furthermore, the terms defined in Embodiment 1 are also used in Embodiment 2 in accordance with their respective definitions, unless otherwise specifically described.

In Embodiment 2, frequency specifying information, to which a video processing circuit (first frequency specifying means) 2 refers, is referred to as first frequency specifying information, and a target blinking frequency, which the video processing circuit 2 specifies, is referred to as a first target blinking frequency.

[Configuration of Display Device]

A display device in accordance with Embodiment 2 will be described below with reference to FIG. 8. FIG. 8 is a block diagram illustrating an example configuration of a main part of a display device 10 in accordance with Embodiment 2. As illustrated in FIG. 8, the display device 10 includes a subtitles display circuit 11, a setting circuit 12, and a text detecting circuit (second frequency specifying means) 13, in addition to the configuration of the display device 1 in accordance with Embodiment 1.

The subtitles display circuit 11 obtains a subtitles signal and, in accordance with the subtitles signal thus obtained, instructs the driving circuit 4 to display a text, such as subtitles or telop, while superimposing the text on a video. The subtitles display circuit 11 notifies the text detecting circuit 13 of a text display notification which indicates that the text, such as subtitles or telop, is being displayed in a given frame.

Note that the subtitles display circuit 11 can obtain the subtitles signal from a device outside the display device 10 via an antenna (not illustrated) or a communication section (not illustrated). Alternatively, the subtitles display circuit 11 can obtain the subtitles signal by reading out the subtitles signal from, for example, a storing section (not illustrated) included in the display device 10. Alternatively, the subtitles display circuit 11 can obtain the subtitles signal from a device, a member, or the like from which the video processing circuit 2 obtains a video signal or can alternatively obtain the subtitles signal from a different device or the like.

The setting circuit 12 displays a menu setting screen, an OSD screen, or the like of the display device 10 and changes setting of the display device 10, in accordance with an operation signal inputted by a user. For example, the setting circuit 12 enables or disables (On or Off) a subtitles display function of the display device 10. The setting circuit 12 notifies the text detecting circuit 13 of a setting screen display notification which indicates that the menu setting screen, the OSD screen, or the like is being displayed. Further, in a case where the setting circuit 12 enables or disables the subtitles display function, the setting circuit 12 notifies the text detecting circuit 13 of a function switch notification which indicates that the subtitles display function is enabled or disabled.

The text detecting circuit 13 detects a text region by determining whether or not a frame to be displayed includes a region in which a text is to be displayed (text region).

The text detecting circuit 13 can determine that a frame to be displayed includes a text region, for example, in a case where the text detecting circuit 13 receives, from the subtitles display circuit 11, a text display notification as to the frame to be displayed. Alternatively, the text detecting circuit 13 can determine that a frame to be displayed includes a text region, in a case where the text detecting circuit 13 receives a setting screen display notification from the setting circuit 12. Alternatively, the text detecting circuit 13 can determine that a frame to be displayed includes a text region, in a case where a function switch notification received from the setting circuit 12 indicates that the subtitles display function of the display device 10 is enabled.

Alternatively, the text detecting circuit 13 can determine that a given frame includes a text region, in a case where the text detecting circuit 13 receives, from another device (device supplying a video signal) such as a BD recorder, a text display signal which indicates that the given frame includes the text region such as subtitles, telop, a menu setting screen, an OSD screen, or the like.

Alternatively, the text detecting circuit 13 can determine whether or not a video in accordance with a video signal for a frame to be displayed includes a text region, by analyzing the video signal. For example, the text detecting circuit 13 extracts edges from a video in accordance with a video signal, and then determines, based on an edge histogram obtained from the edges, whether or not a frame to be displayed includes a text region.

In a case where the text detecting circuit 13 detects a text region, the text detecting circuit 13 specifies a proportion of the text region to an entire image region in a frame, and specifies a second target blinking frequency corresponding to the proportion of the text region thus specified, with reference to second frequency specifying information indicative of a correspondence between a proportion of a text region and a second target blinking frequency. The text detecting circuit 13 notifies the backlight control circuit 3 of the second target blinking frequency thus specified.

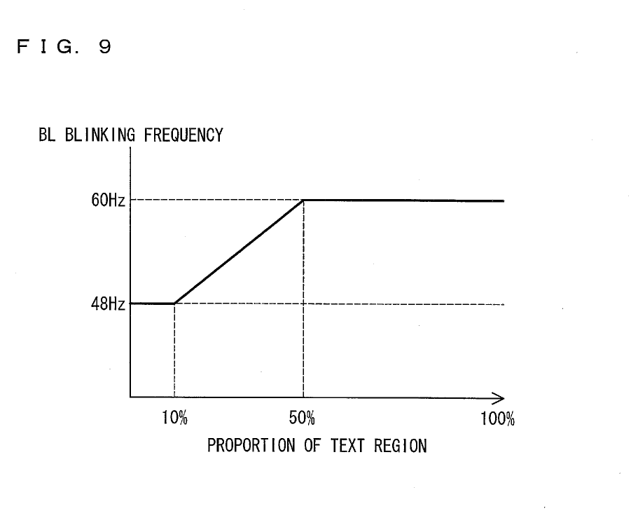

Here, the second frequency specifying information will be described below with reference to FIG. 9. FIG. 9 is a view illustrating an example of second frequency specifying information indicative of a correspondence between (i) a proportion of a text region and (ii) a second target blinking frequency.

According to the second frequency specifying information, the second target blinking frequency increases in proportion to the proportion of the text region (see FIG. 9). According to the example illustrated in FIG. 9, the second target blinking frequency continuously varies depending on the proportion of the text region. Note, however, that the correspondence between (i) the proportion of the text region and (ii) the second target blinking frequency is not limited to one illustrated in FIG. 9, and can be set as appropriate, provided that the second target blinking frequency increases in proportion to the proportion of the text region.

According to Embodiment 2, (i) a lower limit of the second target blinking frequency is set to 48 Hz which corresponds to a frequency of a shutter of a projector and (ii) an upper limit of the second target blinking frequency is set to 60 Hz which corresponds to a general refresh rate (see FIG. 9). Note, however, that the lower limit and the upper limit of the second target blinking frequency are not limited to such respective frequencies, and can be therefore set as appropriate.

The backlight control circuit 3 obtains a first target blinking frequency from the video processing circuit 2, obtains a second target blinking frequency from the text detecting circuit 13, and specifies a target blinking frequency in accordance with the first and second target blinking frequencies thus obtained. For example, the backlight control circuit 3 can specify, as the target blinking frequency, one of the first and second target blinking frequencies whichever is higher.

Alternatively, the backlight control circuit 3 can specify the target blinking frequency with reference to third frequency specifying information indicative of a correspondence between (i) respective first and second target blinking frequencies and (ii) a target blinking frequency. Alternatively, the backlight control circuit 3 can obtain brightness of a video from the video processing circuit 2, obtain a proportion of a text region from the text detecting circuit 13, and specify the target blinking frequency with reference to fourth frequency specifying information indicative of a correspondence between (i) a brightness of a video and a proportion of a text region and (ii) a target blinking frequency.

The backlight control circuit 3 controls, in accordance with the target blinking frequency thus specified, a blinking frequency of light emitted by the backlight 6, as in Embodiment 1.

Alternatively, the backlight control circuit 3 can control the blinking frequency of light merely in accordance with the second target blinking frequency which has been set as the target blinking frequency. That is, the display device 10 can control the blinking frequency of light emitted by the backlight, merely in accordance with a proportion of a text region, without depending on brightness of a video.

[Third Process Carried Out by Display Device]

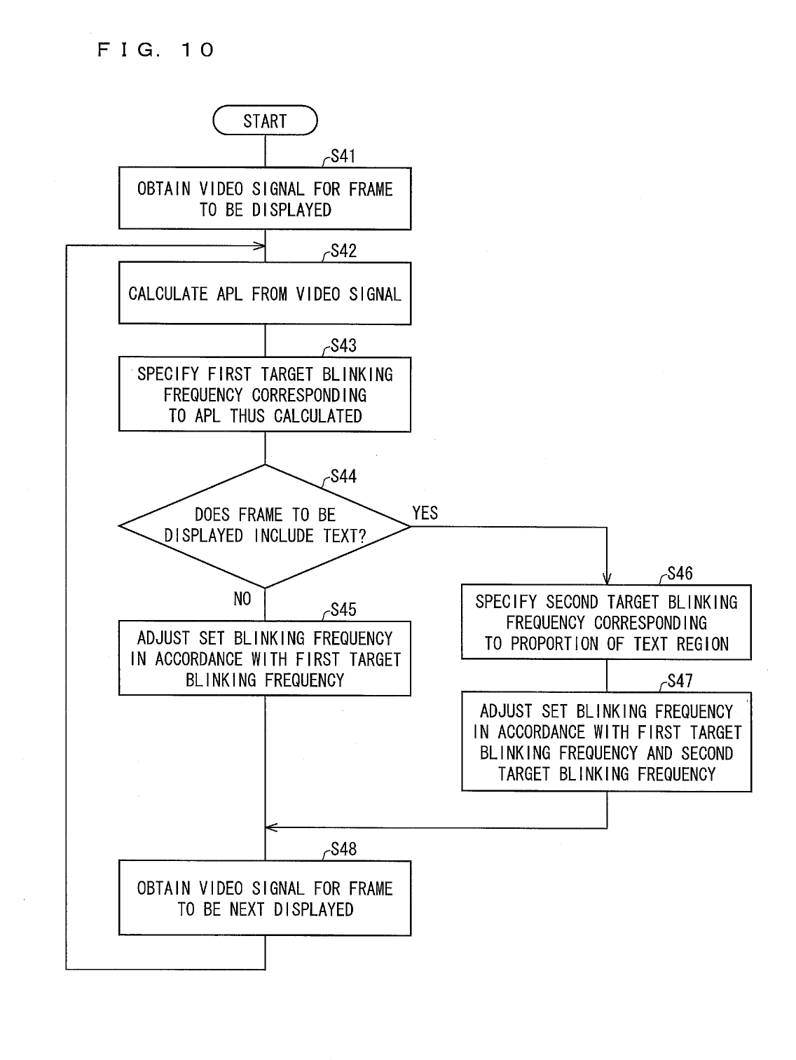

Next, a process (third process) will be described below which is carried out, in a movie (classic) mode, by the display device 10 in accordance with Embodiment 2. FIG. 10 is a flowchart illustrating an example of the third process which is carried out, in the movie (classic) mode, by the display device 10.

As illustrated in FIG. 10, the video processing circuit 2 obtains a video signal for a frame to be displayed (step S41). The video processing circuit 2 calculates an APL from the video signal thus obtained (step S42). The video processing circuit 2 specifies, with reference to given first frequency specifying information, a first target blinking frequency corresponding to the APL thus calculated (step S43), and notifies the backlight control circuit 3 of the first target blinking frequency thus specified.

Next, the text detecting circuit 13 determines whether or not the frame to be displayed includes a text region (step S44). In a case where the text detecting circuit 13 does not detect a text region (No, in the step S44), the backlight control circuit 3 adjusts a set blinking frequency merely in accordance with the first target blinking frequency which has been notified from the video processing circuit 2, assuming that the first target blinking frequency is a target blinking frequency (step S45).

In a case where the text detecting circuit 13 detect a text region (Yes, in the step S44), the text detecting circuit 13 specifies a proportion of the text region to an entire image region of the frame. The text detecting circuit 13 then specifies, with reference to given second frequency specifying information, a second target blinking frequency corresponding to the proportion of the text region thus specified (step S46), and notifies the backlight control circuit 3 of the second target blinking frequency thus specified.

The backlight control circuit 3 adjusts the set blinking frequency in accordance with (i) the first target blinking frequency which has been notified from the video processing circuit 2 and (ii) the second target blinking frequency which has been notified from the text detecting circuit 13 (step S47).

After the backlight control circuit 3 carries out the process (S45 or S47), the video processing circuit 2 waits to receive a video signal for a next frame. In a case where the video processing circuit 2 receives the video signal for the next frame (step S48), the process in the step S42 and the processes in subsequent steps are again carried out.

[Example Implementation by Software]

Finally, each block of the display device 1, especially, the video processing circuit 2, the backlight control circuit 3, the subtitles display circuit 11, the setting circuit 12, and the text detecting circuit 13 can be implemented by hardware logic or can be alternatively implemented by software with the use of a CPU as below.

That is, the display device 1 includes: a CPU (Central Processing Unit) which executes instructions of a control program that carries out the foregoing functions; and a storage device (recording medium) such as a ROM (Read Only Memory) which stores the program, a RAM (Random Access Memory) in which the program is loaded, and a memory which stores the program and various sets of data. The object of the present invention can be attained by (i) supplying, to the display device 1, the recoding medium in which program codes (an executable program, an intermediate code program, and a source program) of a control program for controlling the display device 1, which is implemented by software that executes the foregoing functions, are computer-readably recorded and (ii) causing a computer (or a CPU or an MPU) of the display device 1 to read and execute the program codes recorded in the recording medium.

Examples of the recording medium includes: (i) tapes such as a magnetic tape and a cassette tape; (ii) disks including magnetic disks, such as a Floppy (Registered Trademark) disk and a hard disk, and optical disks, such as a CD-ROM, an MO, an MD, a DVD, and a CD-R; (iii) cards such as an IC card (including a memory card) and an optical card; and (iv) semiconductor memories such as a mask ROM, EPROM, EEPROM (Registered Trademark), and a flash ROM.

The display device 1 can be connected to a communication network so that the program codes are supplied to the display device 1 via the communication network. This communication network is not limited to any particular one. Examples of the communication network include the Internet, an intranet, an extranet, a LAN, ISDN, VAN, a CATV communications network, a virtual private network, a telephone network, a mobile telecommunications network, and a satellite communication network. Further, a transmission medium by which the communication network is constituted is not limited to any particular one. Examples of the transmission medium include: wired transmission media such as IEEE 1394, a USB, a power-line carrier, a cable TV circuit, a telephone line, and ADSL; and wireless transmission media such as infrared communication systems such as IrDA and a remote control, Bluetooth (Registered Trademark), IEEE802.11 wireless communication system, HDR, a mobile phone network, a satellite circuit, and a digital terrestrial network. Note that the present invention can also be implemented in a form of a computer data signal in which the program codes are embodied by an electronic transmission and which is embedded in carrier waves.

### SUMMARY

A display device according to an aspect 1 of the present invention is a display device, which displays a video on a display section including a backlight, including: backlight control means for controlling a blinking frequency of light emitted by the backlight, the backlight control means controlling the blinking frequency of the light emitted by the backlight, in accordance with brightness of the video.

In a movie (classic) mode, the backlight control means controls the blinking frequency of the light emitted by the backlight so as to reproduce a feeling of shutter, which is felt when a film movie is projected by a projector. Note here that, in a case where the backlight is uniformly operated at a blinking frequency of, for example, 48 Hz regardless of the brightness of the video as in a conventional technique, this may cause a user to feel a feeling of flicker rather than the feeling of shutter.

In view of the circumstances, according to the above configuration, the backlight control means controls the blinking frequency of the light emitted by the backlight, in accordance with the brightness of the video to be displayed. It is therefore possible to suppress the feeling of flicker. Moreover, it is possible to reproduce the feeling of shutter with a simple process of controlling the blinking frequency of the light emitted by the backlight.

Therefore, it is possible to reproduce, with a simpler process, the feeling of shutter, which is felt when a film movie is projected by a projector, without causing the user to feel a feeling of discomfort.

A display device, as set forth in the aspect 1, in accordance with an aspect 2 of the present invention can further include: frequency specifying means for specifying a target blinking frequency corresponding to the brightness of the video, the backlight control means controlling the blinking frequency of the light emitted by the backlight, in accordance with the target blinking frequency specified by the frequency specifying means.

According to the above configuration, the frequency specifying means specifies a target blinking frequency suitable for the brightness of the movie, and the backlight control means controls, in accordance with the target blinking frequency, the blinking frequency of the light emitted by the backlight. It is therefore possible to reproduce the feeling of shutter at the blinking frequency suitable for the brightness of the video.

The display device, as set forth in the aspect 2, in accordance with an aspect 3 of the present invention can be arranged such that, in a case where the blinking frequency of the light emitted by the backlight is different from the target blinking frequency, the backlight control means gradually increases or decreases the blinking frequency of the light emitted by the backlight so that the blinking frequency is identical to the target blinking frequency.

According to the above configuration, the backlight control means gradually increases or decreases the blinking frequency of the light emitted by the backlight. This causes the feeling of shutter to be reproduced at the blinking frequency suitable for the brightness of the video while a sudden change in blink frequency is being suppressed. It is therefore possible to suppress the feeling of discomfort or a feeling of strangeness caused by a change in blinking frequency.

The display device, as set forth in the aspect 3, in accordance with an aspect 4 of the present invention is preferably arranged such that the backlight control means decreases the blinking frequency, of the light emitted by the backlight, by an amount smaller than an amount by which the backlight control means increases the blinking frequency.

According to the above configuration, the backlight control means decreases the blinking frequency by an amount smaller than an amount by which the backlight control means increases the blinking frequency. By decreasing the blinking frequency, the feeling of flicker tends to be strong. Therefore, by decreasing the blinking frequency by a smaller amount, it is possible to suppress the feeling of discomfort caused by a change in blink frequency.

The display device, as set forth in the aspect 3, in accordance with an aspect 5 of the present invention can be arranged such that the backlight control means sets a decrease interval, between (i) a time point when the backlight control means once decreased the blinking frequency of the light emitted by the backlight and (ii) a time point when the backlight control means next decreases the blinking frequency, so as to be longer than an increase interval, between (a) a time point when the backlight control means once increased the blinking frequency and (b) a time point when the backlight control means next increases the blinking frequency.

According to the above configuration, the backlight control means set the decrease interval so as to be longer than the increase interval. By decreasing the blinking frequency, the feeling of flicker tends to be strong. Therefore, by setting the decrease interval so as to be longer than the increase interval, it is possible to suppress the feeling of discomfort caused by a change in blink frequency.

The display device, as set forth in the aspects 1 through 5, in accordance with an aspect 6 of the present invention can be arranged such that the backlight is divided into a plurality of regions; and the backlight control means merely controls a blinking frequency of light emitted from one or more of the plurality of regions of the backlight which one or more of the plurality of regions corresponds to a region on the display section in which region the video is being displayed.

According to the above configuration, the backlight control means merely controls a blinking frequency of light emitted from a region of the backlight which region corresponds to a region on the display section in which region the video is displayed. Therefore, even in a case where the video and a content other than the video (for example, text information) are displayed on the display section, it is possible to display the video and the content while reproducing the feeling of shutter merely in the region in which the video is displayed.

The display device, as set forth in the aspect 1, in accordance with an aspect of the present invention can be arranged such that the backlight control means controls the blinking frequency of the light emitted by the backlight, in accordance with the brightness of the video and a proportion of a text region included in the video.

In the movie (classic) mode, the backlight control means controls the blinking frequency of the light emitted by the backlight so as to reproduce the feeling of shutter, which is felt when a film movie is projected by a projector. Note here that, in a case where not only the brightness but also a region in which a text is displayed is increased in the video, this may cause the user to feel the feeling of flicker rather than the feeling of shutter.

According to the above configuration, the backlight control means controls the blinking frequency of the light in accordance with the brightness and the proportion of the text region. Therefore, even in a case where the region in which the text is displayed is increased in the video, it is possible to suppress the feeling of flicker and possible to reproduce the feeling of shutter.

A method of controlling a display device in accordance with an aspect 7 of the present invention is a method of controlling a display device which displays a video on a display section including a backlight, including the step of: (a) controlling a blinking frequency of light emitted by the backlight, in the step (a), the blinking frequency of the light emitted by the backlight being controlled in accordance with brightness of the video.

Further, a television receiver including the display device also falls within the scope of the present invention.

Note that the display device can be realized by a computer. In this case, (i) a control program for causing a computer to function as each means of the display device and (ii) a computer-readable recording medium in which the control program is recorded also fall within the scope of the present invention.

The present invention is not limited to the description of the embodiments, but may be altered by a skilled person in the art within the scope of the claims. An embodiment derived from a proper combination of technical means disclosed in different embodiments is also encompassed in the technical scope of the present invention.

### INDUSTRIAL APPLICABILITY

A display device in accordance with the present invention is applicable to wide range of display devices such as a television.

### REFERENCE SIGNS LIST

1, 10 Display device
2 Video processing circuit (frequency specifying means, first frequency specifying means)
3 Backlight control circuit (backlight control means)
4 Driving circuit
5 Display panel
6 Backlight
7 Display section
11 Subtitles display circuit
12 Setting circuit
13 Text detecting circuit (second frequency specifying means)

1. A display device, which displays a video on a display section including a backlight, comprising:
a backlight control section for controlling light-emission of the backlight so as to cause blinking of light emitted by the backlight,
the backlight control section controlling a blinking frequency, which is a frequency of the blinking, so that, as brightness of a video signal indicative of the video becomes brighter, the blinking frequency becomes higher.

2. A display device as set forth in claim 1, further comprising:
a frequency specifying section for specifying a target blinking frequency corresponding to the brightness of the video signal,
the backlight control section controlling the blinking frequency in accordance with the target blinking frequency specified by the frequency specifying section.

3. The display device as set forth in claim 2, wherein, in a case where the blinking frequency is different from the target blinking frequency, the backlight control section gradually increases or decreases the blinking frequency so that the blinking frequency is identical to the target blinking frequency.

4. The display device as set forth in claim 3, wherein the backlight control section decreases the blinking frequency by an amount smaller than an amount by which the backlight control section increases the blinking frequency.

5. The display device as set forth in claim 3, wherein the backlight control section sets a decrease interval, between (i) a time point when the backlight control section once decreased the blinking frequency and (ii) a time point when the backlight control section next decreases the blinking frequency, so as to be longer than an increase interval, between (a) a time point when the backlight control section once increased the blinking frequency and (b) a time point when the backlight control section next increases the blinking frequency.

6. The display device as set forth in claim 1, wherein:
the backlight is divided into a plurality of regions; and
the backlight control section merely controls one or more of the plurality of regions of the backlight, which one or more of the plurality of regions corresponds to a region on the display section in which region the video is being displayed, to cause the blinking.

7. The display device as set forth in claim 1, wherein the backlight control section controls the blinking frequency so that, (i) as the brightness of the video signal becomes brighter, the blinking frequency becomes higher and, (ii) as a proportion of a text region included in the video becomes higher, the blinking frequency becomes higher.

8. A method of controlling a display device which displays a video on a display section including a backlight, comprising the step of:
(a) controlling light-emission of the backlight so as to cause blinking of light emitted by the backlight,
in the step (a), a blinking frequency, which is a frequency of the blinking, being controlled so that, as brightness of a video signal indicative of the video becomes brighter, the blinking frequency becomes higher.

9. A television receiver comprising a display device recited in claim 1.

10. (canceled)

11. A non-transitory computer-readable recording medium in which a control program is recorded,
the control program causing a computer to function as each section of a display device recited in claim 1.

12. The display device as set forth in claim 1, wherein the backlight control section causes the blinking, which is a repeat of a light-emitting time and a non-light-emitting time whose length is identical to that of the light-emitting time.
